(19) United States
(12) Patent Application Publication
(10) Pub. No.: US 2024/0083631 A1
(43) Pub. Date: Mar. 14, 2024

(54) METHOD OF DIVIDING AND TRANSFERRING THE SEMI-SOLID TYPE FOOD IN PET FOOD CANS INTO EQUAL PORTIONS WITHOUT USING A KNIFE OR OTHER KITCHEN TOOLS

(71) Applicant: ANKA RAO CHATRAGADDA, LINCOLN, RI (US)

(72) Inventor: ANKA RAO CHATRAGADDA, LINCOLN, RI (US)

(21) Appl. No.: 18/378,048

(22) Filed: Oct. 9, 2023

(51) Int. Cl. B65D 25/04

(52) U.S. Cl. CPC B65D 25/04

(57) ABSTRACT

This invention presents a unique method for slicing semi-solid or pate pet canned food using a specially designed container outlined in point [0036]. The method, detailed in this invention, effortlessly divides the pet food into equal portions without the need for a knife or other kitchen tools. Beyond facilitating easy division, the method transfers these portions into the container specified in [0036]. This innovation relieves pet owners of the need to estimate and portion meals each time a new pet food can is opened, fostering a consistent feeding routine. The method not only saves time previously spent on manual portioning, which often results in inaccuracies, but also assures pet owners that their pets receive appropriately sized meals. By preventing underfeeding and overfeeding, it contributes to avoiding malnutrition and obesity. An additional feature allows the infusion of prescribed or over-the-counter drugs into individual portions according to veterinary recommendations.

### CROSS-REFERENCE TO RELATED APPLICATION (S)

This application claims the benefit of and priority to U.S. Provisional App. No. 63/431,375, filed on Dec. 9, 2022

This application claims the benefit of and priority to U.S. Non-Provisional Design App. No. 29904532, filed on Oct. 9, 2023

### FIELD OF THE INVENTION

The present disclosure is a method of dividing the semi-solid form food in a pet food Can into equal portions and transferring the divided food portions from food Can into the Container manufactured using the design disclosed under the design patent application cited in point number [0002].

### BACKGROUND OF THE INVENTION

In today's method of feeding a prescription diet to pets suffering with a chronic health condition is based on two factors: first, the weight of the pet, and second, the veterinarian recommended quantity or portion of the food. In particular, the present disclosure relates to a prescription diet or regular food available in the market in “Canned & Semi-solid” form. A number of steps are required to be performed by pet owners to divide the food available in the canned form into equal portions. For instance, a considerable amount of time is spent by a pet owner trying to divide the food in the food Can into the appropriate portion recommended for his/her pet, and this is an exercise that must be done manually by the pet owners every time a new prescription food Can or OTC food Can is opened. It is humanly not possible to divide the food available in a canned form into equal portions using eyeballing or manually, which puts a pet at a risk of either malnutrition (if a less meal quantity is fed) or Obese (if a quantity more than recommended by veterinarian is fed).

The method described in point number [0004] in general practice today, also creates a bit dissatisfaction to the pet owners as they cannot serve the same size meal every time due to the manually dividing the food supplied in a Canned form into equal portions.

Over the odor and hygiene concerns, the pet owners may be reluctant to store the left-over lid opened pet food Cans into their household refrigerators along with their food.

The food Cans available in the market are made using metal, which is not microwave safe, whereas the Container made using the design described under point number [0002] is microwave safe.

### BRIEF SUMMARY OF THE INVENTION

Feeding the right size meal to a pet is a critical activity. Often, the pet owners divide the Canned food into equal portions by eyeballing the quantity size of a given meal. Eyeballing the meal portion size or trying to divide the food supplied in a Can into equal portions using a bare hands mechanism doesn't work all the time, and the pet owner has to go through the exercise of dividing Canned food into equal portions at every meal time when a new food Can is opened. The current practice or method described under this point to divide the food into equal portions creates few problems described further.

First Problem is that either feeding a pet less, more or unequal meal size. This problem can lead to malnutrition (if a smaller quantity/portion is fed on a regular basis) and to obesity (if a larger quantity/portion is fed on a regular basis). Especially, it becomes critical to feed the pet on prescription diets with chronic health conditions in correct size recommendations by Veterinarians.

The second problem surfaces when there is a need to refrigerate the leftover food in the original Cans into a household refrigerator. The second problem creates a pet food odor in the household refrigerator. This is a huge problem for pet lovers who don't like pet food odor in their household refrigerator.

The third problem surfaces when there is a need to refrigerate the leftover food in the original Cans into a household refrigerator and the leftover food Cans are not properly sealed. Due to the refrigeration, the third problem creates moisture in the leftover food in the food Cans.

The fourth problem surfaces when pet Canned food should be microwaved. The problem is that it is not safe to microwave the original metal food Cans supplied by the manufacturers.

The invention cited under point number disclosed a design of unique plastic container which solves the problems referenced under point [0008], [0009], [0010], [0011] & [0012] in a hands-free manner.

The invention cited under point number [0002] created a byproduct method of dividing the food in a pet food Can into equal portions and transferring the divided food into the Container cited in pointer number [0013] easily.

The disclosure of this invention is a unique step-by-step method created by the usage of the Container invented and cited under point number [0002].

### BRIEF DESCRIPTION OF THE DRAWINGS

FIG. 1 is showing a sketch view of the container manufactured using the design disclosed under the patent application cited in point number[0002]

FIG. 2 is showing standing and slightly tilted views of the full functional Container manufactured using the design disclosed under the patent application cited in point number [0002]

FIG. 3 to FIG. 5 are the general steps necessary to open the lid of a food Can, and these actions shown in the FIG. 3, FIG. 4 & FIG. 5 are not claimed as part of this invention

FIG. 3 is showing a pet food Can and a lid opener

FIG. 4 is showing that user is opening the lid of the pet food Can with the lid opener

FIG. 5 is showing a lid-opened pet food Can and the lid is completely taken out

FIG. 6 is showing the side-by-side view of lid-opened pet food Can and the Container manufactured using the patent application cited under point number [0002]

FIG. 7 is showing the Container manufactured using the patent application cited under point number placed upside down on the lid-opened pet food Can

FIG. 8 is showing that user is gently pushing down the Container

FIG. 9 is showing that the Container is pushed all the way down, so it hits the bottom of the lid-opened food Can

FIG. 10 is showing a view of the lid-opened food Can is fully inserted into the Container

FIG. 11 is showing that by using a hand flipping the Container upside down

FIG. 12 is showing that by using a hand flipping the Container upside down

FIG. 13 is showing the bottom of the lid-opened food Can inside the Container. Now, the Container is straight and the lid-opened food Can is upside down.

FIG. 14 is showing placing fingers in the gap's arrangement provided by the Container to grip on the bottom of the lid-opened food Can

FIG. 15 is showing the pulling of the lid-opened food Can with fingers out of the Container

FIG. 16 is showing that the food in the pet food Can is divided into equal portions and transferred the parts into the compartments of the Container. Now, lid-opened pet food Can is empty

FIG. 17 is showing that the equally cut food portions are settled in the compartments of the Container

FIG. 18 is showing that the user is placing a cap on the Container

FIG. 19 is showing that food in the Container is secured with a cap and ready to go into the house hold refrigerator

### DETAILED DESCRIPTION OF THE INVENTION

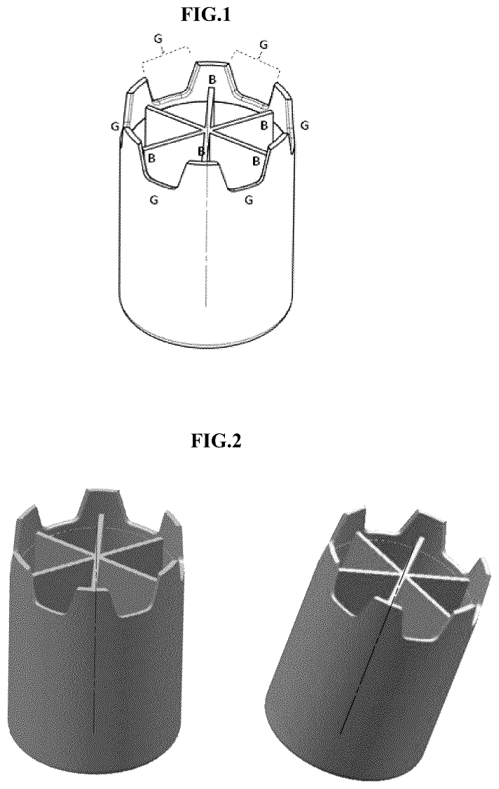

The invention is a method dividing the food in a pet food Can into equal portions and transferring the cut portions into a unique Container manufactured using the design non-provisional patent application cited under point number [0002]. The visuals of the Container described under point [0002] is shown on figures FIG. 1 and FIG. 2

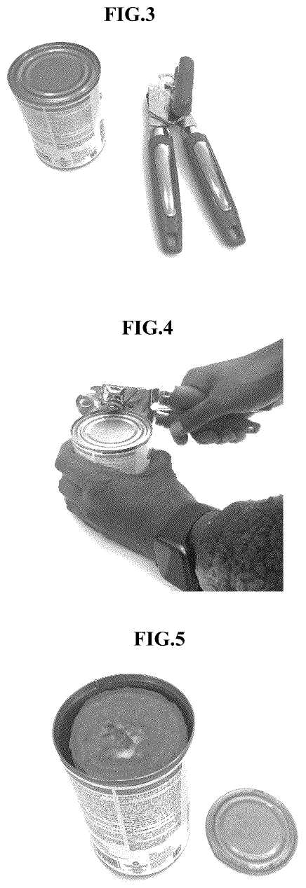

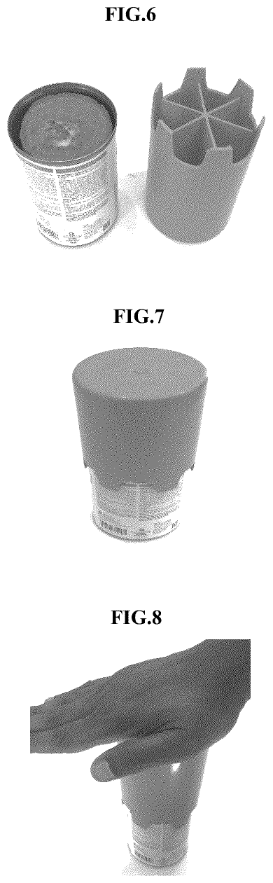

The actions shown in FIG. 3, FIG. 4 and FIG. 5 are commonly used steps to take out the lid of a food Can. These steps are not claimed as part of the method disclosed under this invention

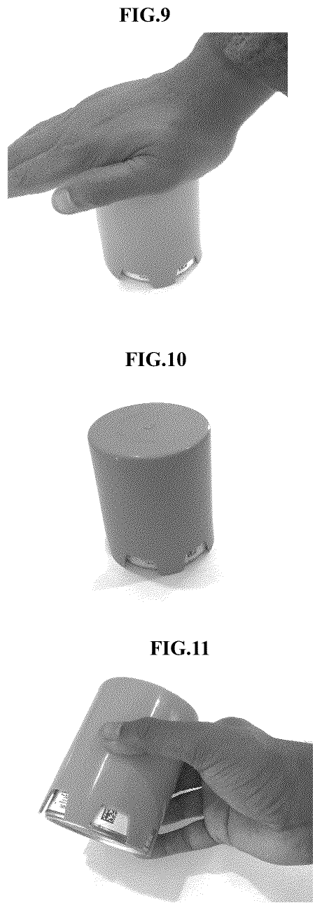

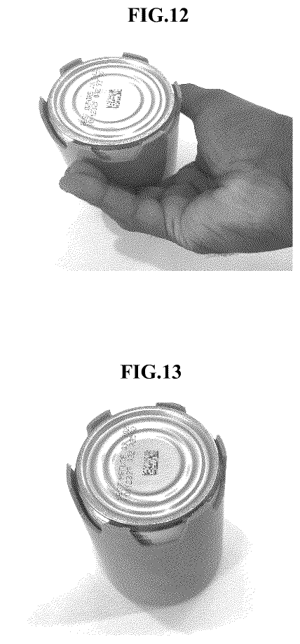

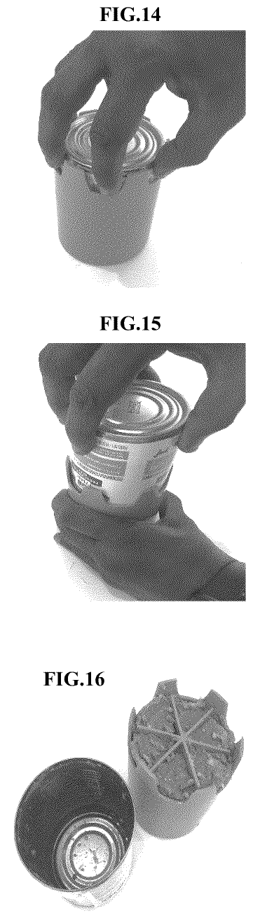

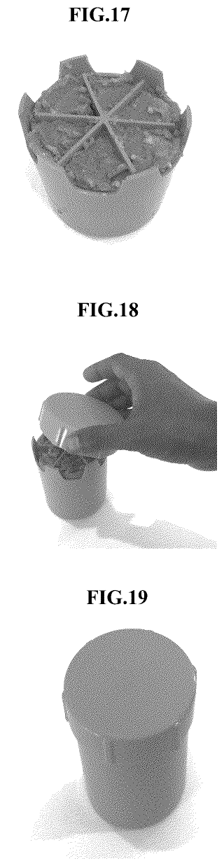

The actions shown in FIG. 7, FIG. 8, FIG. 9, FIG. 10, FIG. 11, FIG. 12, FIG. 13, FIG. 14, FIG. 15, FIG. 16 & FIG. 17 in the same sequence demonstrates a unique method of cutting or dividing and easily transferring the food in the food Can without using a knife or other kitchen tools into the Container made using the design cited under the point number [0002].

The unique method disclosed under this invention is performing the actions shown in the FIG. 7 to FIG. 17 in the same sequence.

The figures FIG. 3, FIG. 4 & FIG. 5 are showing opening the lid of a pet food Can.

After the action performed as described under point [0040], place the Container made described in point number [0036] upside down on the lid opened food Can as described under point [0038]. This action is shown in FIG. 7

After the action performed as described under point [0041], gently push down the container described in point number [0036] with your palm until the container hits the bottom of the food Can. This action is shown in FIG. 8 & FIG. 9

After the action described in point number [0042], the user will have a food Can fully inserted into the upside-down Container described in the point number [0036]. This action is shown in FIG. 10

Using the hand, now flip the Container which was upside down, so the user will now see the bottom of the food Can inserted. These actions are shown in FIG. 11, FIG. 12 & FIG. 13

After the action described in point number [0044], place the fingers around the bottom of the food Can inserted at the finger gaps provided on the Container described in point number [0036], now gently pull out the food Can inserted, if needed give few taps and twists on the bottom of the food Can inserted to pull out. These actions are shown in FIG. 14 & FIG. 15

After the action described in point number [0045], the semi-solid food in the Can is cut into equal portions, and the divided food portions are transferred into the Container described in the point number [0036]. This effect shown in figures FIG. 16 & FIG. 17

The actions described under the points [0041], [0042], [0043], [0044], and [0046] and their sequence creates a method of dividing the food in a food Can into equal portions without using a knife or any other kitchen tools and transfer the divided food into a reusable Container in a hands-free manner.

The method of using the Container designed described under point [0036] and the method described under point [0047] solves the problem described in the point number [0008] by simply dividing the food in the Can into equal portions. Now, the user can choose to feed any number of divided portions to their pets based on the veterinarian recommended meal size

The method of using the Container designed described under point [0036] and the method described under point [0047] solves the problem described in the point number [0009] by closing the container described in the point number [0036] with lid, so the odor or pet food is not spilling or leaking into household refrigerator

The method of using the Container designed described under point [0036] and the method described under point [0047] solves the problem of moisture described in point number[0010] with the help of the lid placed on the container described in the point number[0036]

The method of using the Container designed described under point [0036] and the method described under point [0047] solves the problem described in point number [0011] because the Container described in the point number [0036] is made with food grade FDA approved material which is compatible with microwaves & dishwashers' usage

1. The method of dividing the food in the lid opened pet food Can into equal portions without using a knife or other kitchen cutting tools, and easily transferring the divided or cut food portions in the food Can into the Container described in the point number [0036]
The method of performing the actions described in the points [0041], [0042], [0043], [0044], [0045] and [0046] and their sequence using the Container described in the point number [0036]
The Container described in the point number and the Method described in point number can also be used for human grade Canned foods and other soft foods that a user would like divide them into equal portions.
